(19) United States
(12) Patent Application Publication
(10) Pub. No.: US 2026/0279075 A1
(43) Pub. Date: Sep. 17, 2026

(54) SYSTEM FOR EVALUATING DRIVING STATE OF DRIVER

(71) Applicant: SoftBank Group Corp., Tokyo (JP)

(72) Inventor: Hiroki KANI, Tokyo (JP)

(21) Appl. No.: 19/561,532

(22) Filed: Mar. 10, 2026

Related U.S. Application Data
(60) Provisional application No. 63/769,779, filed on Mar. 11, 2025.

(51) Int. Cl. G06V 20/59; B60K 35/26; G06N 20/00; G06V 20/52; G06V 40/16; G06V 40/18; G10L 25/51

(52) U.S. Cl. CPC G06V 20/597; B60K 35/265; G06N 20/00; G06V 20/52; G06V 40/161; G06V 40/18; G10L 25/51; B60K 2360/178; B60K 2360/741

(57) ABSTRACT

A drive recorder system is equipped with a conversational AI to reduce the risk of traffic accidents. This system includes a camera unit, a microphone unit, a communication unit, a processing unit, and an output unit, and monitors the driver's condition in real time. The camera unit monitors the driver's face and detects the blinking frequency and eye opening and closing time to detect drowsiness and inattention at an early stage. The microphone unit analyzes in-vehicle audio and determines fatigue and stress from changes in voice tone and manner of speaking. These data are transmitted to a server via the communication unit and are integrally analyzed by the processing unit. A generative AI generates appropriate advice for the driver based on the analysis results and provides it by voice through the output unit.

### CROSS-REFERENCE TO RELATED APPLICATIONS

This application is based upon and claims the benefit of priority from U.S. Provisional Patent Application No. 63/769,779, filed on Mar. 11, 2025, the entire contents of which are incorporated herein by reference.

### BACKGROUND

Japanese Unexamined Patent Publication No. 2022-180282 discloses a method, which is a persona chatbot control method performed by at least one processor, the method including a step of receiving a user utterance, a step of adding the user utterance to a prompt including an instruction sentence associated with a description regarding a character of a chatbot, a step of encoding the prompt, and a step of inputting the encoded prompt to a language model to generate a chatbot utterance responding to the user utterance.

### SUMMARY

A problem to be solved by this disclosure is to suppress the occurrence of traffic accidents and ensure the safety of drivers. For example, the objective is to improve the current situation in which more than 2,600 fatalities and more than 360,000 injuries occur due to more than 300,000 traffic accidents per year. In particular, since driver drowsiness, inattention, and dangerous driving are the main causes of accidents, the aim is to reduce the risk of accidents by detecting these factors in real time and providing appropriate warnings and advice to the driver. In addition, a problem is to promote safe driving in the long term and contribute to the reduction of traffic accidents by learning the driving patterns of drivers and providing support optimized for individual drivers. Thus, a problem to be solved is to improve traffic safety by monitoring the driver's condition using technical means and providing appropriate feedback.

Disclosed herein is a system including a camera unit, a microphone unit, and a processing unit. The camera unit has a function of constantly monitoring the driver's face and detecting information such as blinking frequency, eye opening and closing time, gaze direction, and head tilt in real time. This makes it possible to quickly capture signs of driver drowsiness or inattention. The microphone unit has a function of collecting in-vehicle audio and analyzing changes in the driver's voice tone and manner of speaking, and determines signs of stress or fatigue. The processing unit integrates the data acquired from the camera unit and the microphone unit and comprehensively evaluates the driver's condition. When drowsiness or dangerous driving is detected, the processing unit has a function of providing a voice warning to the driver. This makes it possible to provide immediate feedback to the driver and promote safe driving. Thus, the objective is to reduce the risk of traffic accidents and improve safety by having each unit cooperate to monitor the driver's condition and take appropriate action.

### BRIEF DESCRIPTION OF THE DRAWINGS

FIG. 1 is a conceptual diagram illustrating an example of a configuration of a data processing system according to a first embodiment.

FIG. 2 is a conceptual diagram illustrating an example of main functions of a data processing apparatus and a smart device according to the first embodiment.

FIG. 3 is a conceptual diagram illustrating an example of a configuration of a data processing system according to a second embodiment.

FIG. 4 is a conceptual diagram illustrating an example of main functions of a data processing apparatus and smart glasses according to the second embodiment.

FIG. 5 is a conceptual diagram illustrating an example of a configuration of a data processing system according to a third embodiment.

FIG. 6 is a conceptual diagram illustrating an example of main functions of a data processing apparatus and a headset-type terminal according to the third embodiment.

FIG. 7 is a conceptual diagram illustrating an example of a configuration of a data processing system according to a fourth embodiment.

FIG. 8 is a conceptual diagram illustrating an example of main functions of a data processing apparatus and a robot according to the fourth embodiment.

FIG. 9 illustrates an emotion map on which a plurality of emotions are mapped.

FIG. 10 illustrates an emotion map on which a plurality of emotions are mapped.

FIG. 11 is a flowchart illustrating an example of a method for evaluating a driving state of a driver.

### DETAILED DESCRIPTION

Hereinafter, example systems according to the technology of the present disclosure will be described with reference to the accompanying drawings.

First, terms used in the following description will be described.

In the following embodiments, a processor with a reference sign (hereinafter, simply referred to as a “processor”) may be one arithmetic device or may be a combination of a plurality of arithmetic devices. Also, the processor may be one type of arithmetic device or may be a combination of a plurality of types of arithmetic devices. Examples of the arithmetic device include a CPU (Central Processing Unit), a GPU (Graphics Processing Unit), a GPGPU (General-Purpose computing on Graphics Processing Units), an APU (Accelerated Processing Unit), and the like.

In the following embodiments, a RAM (Random Access Memory) with a reference sign is a memory in which information is temporarily stored, and is used as a work memory by a processor.

In the following embodiments, a storage with a reference sign is one or more non-volatile storage devices that store various programs, various parameters, and the like. Examples of the non-volatile storage device include a flash memory (SSD (Solid State Drive)), a magnetic disk (for example, a hard disk), or a magnetic tape, and the like.

In the following embodiments, a communication I/F (Interface) with a reference sign is an interface including a communication processor, an antenna, and the like. The communication I/F manages communication among a plurality of computers. An example of a communication standard applied to the communication I/F includes a wireless communication standard including 5G (5th Generation Mobile Communication System), Wi-Fi (registered trademark), or Bluetooth (registered trademark), and the like.

In the following embodiments, “A and/or B” is synonymous with “at least one of A and B”. That is, “A and/or B” means that it may be A only, B only, or a combination of A and B. Also, in the present specification, when three or more matters are expressed by being connected with “and/or”, the same concept as “A and/or B” is applied.

### First Embodiment

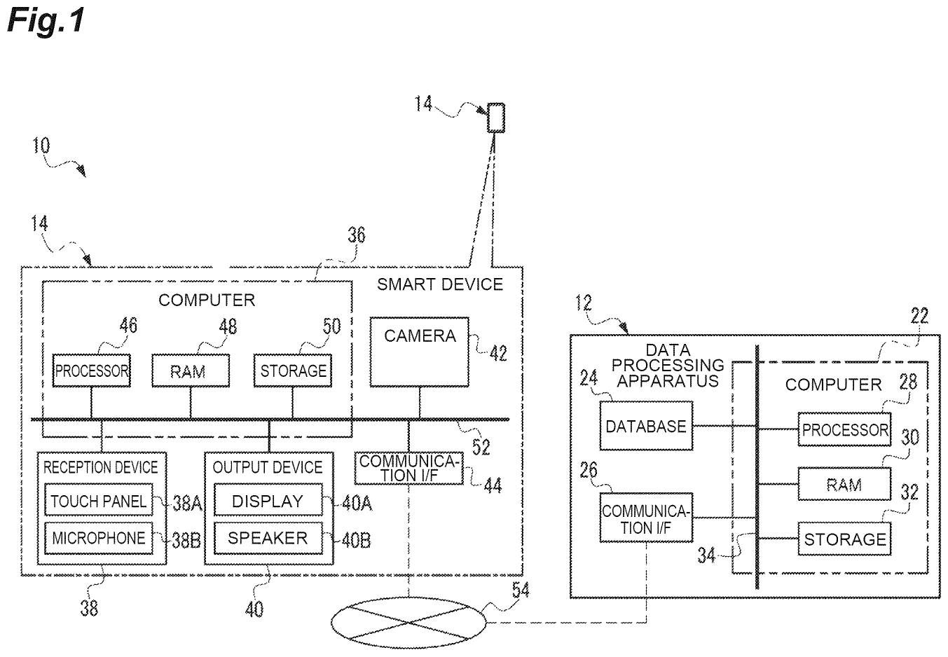

FIG. 1 illustrates an example of a configuration of a data processing system 10 according to a first embodiment.

As illustrated in FIG. 1, the data processing system 10 includes a data processing apparatus 12 and a smart device 14. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The smart device 14 includes a computer 36, a reception device 38, an output device 40, a camera 42, and a communication I/F 44. The computer 36 includes a processor 46, a RAM 48, and a storage 50. The processor 46, the RAM 48, and the storage 50 are connected to a bus 52. Also, the reception device 38, the output device 40, and the camera 42 are also connected to the bus 52.

The reception device 38 includes a touch panel 38A, a microphone 38B, and the like, and receives a user input. The touch panel 38A receives a user input by contact of an indicator by detecting contact of the indicator (for example, a pen or a finger, etc.). The microphone 38B receives a user input by voice by detecting a user's voice. A control unit 46A transmits data indicating the user input received by the touch panel 38A and the microphone 38B to the data processing apparatus 12. In the data processing apparatus 12, a specific processing unit 290 acquires the data indicating the user input.

The output device 40 includes a display 40A, a speaker 40B, and the like, and presents data to a user 20 by outputting the data in a representation form (for example, voice and/or text) perceivable by the user 20. The display 40A displays visible information such as text and images in accordance with an instruction from the processor 46. The speaker 40B outputs voice in accordance with an instruction from the processor 46. The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted.

The communication I/F 44 is connected to the network 54. The communication I/Fs 44 and 26 manage exchange of various information between the processor 46 and the processor 28 via the network 54.

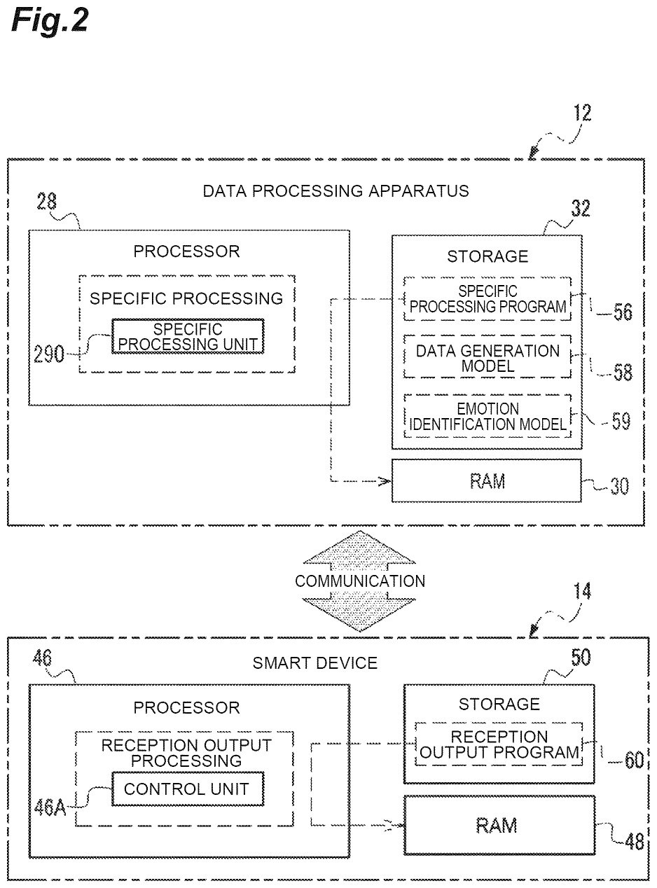

FIG. 2 illustrates an example of main functions of the data processing apparatus 12 and the smart device 14.

As illustrated in FIG. 2, in the data processing apparatus 12, specific processing is performed by the processor 28. A specific processing program 56 is stored in the storage 32. The specific processing program 56 is an example of a “program” according to the technology of the present disclosure. The processor 28 reads the specific processing program 56 from the storage 32 and executes the read specific processing program 56 on the RAM 30. The specific processing is realized by the processor 28 operating as a specific processing unit 290 in accordance with the specific processing program 56 executed on the RAM 30.

A data generation model 58 and an emotion identification model 59 are stored in the storage 32. The data generation model 58 and the emotion identification model 59 are used by the specific processing unit 290. The specific processing unit 290 can estimate a user's emotion using the emotion identification model 59 and perform specific processing using the user's emotion. In an emotion estimation function (emotion identification function) using the emotion identification model 59, various estimations and predictions regarding the user's emotion, including estimation and prediction of the user's emotion, are performed, but is not limited to such examples. Also, the estimation and prediction of emotion include, for example, analysis (analytics) of emotion and the like.

The specific processing unit 290 may be configured to utilize a dedicated hardware accelerator (for example, an NPU: Neural Processing Unit or a GPU) within the processor 28 in inference processing of the data generation model 58 and the emotion identification model 59. The specific processing unit 290 may adopt a distributed processing architecture in which lightweight preprocessing is performed on the acquired sensor data (images, voice) on the edge side (smart device 14) to extract only feature values related to privacy and encrypt them, and then the encrypted feature values are transmitted to the data processing apparatus 12 on the server side. This provides a security effect of physically blocking a risk of leakage of raw data while suppressing consumption of network bandwidth and ensuring real-time performance.

In the smart device 14, reception output processing is performed by the processor 46. A reception output program 60 is stored in the storage 50. The reception output program 60 is used in combination with the specific processing program 56 by the data processing system 10. The processor 46 reads the reception output program 60 from the storage 50 and executes the read reception output program 60 on the RAM 48. The specific processing is realized by the processor 46 operating as a control unit 46A in accordance with the reception output program 60 executed on the RAM 48. Note that the smart device 14 can also have a data generation model and an emotion identification model similar to the data generation model 58 and the emotion identification model 59, and perform processing similar to that of the specific processing unit 290 using these models. The reception output processing is realized by the processor 46 operating as the control unit 46A in accordance with the reception output program 60 executed on the RAM 48.

Note that an apparatus other than the data processing apparatus 12 may have the data generation model 58. For example, a server apparatus (for example, a generation server) may have the data generation model 58. In this case, the data processing apparatus 12 obtains a processing result (such as a prediction result) in which the data generation model 58 is used, by communicating with the server apparatus having the data generation model 58. Also, the data processing apparatus 12 may be a server apparatus, or may be a terminal device owned by a user (for example, a mobile phone, a robot, a home appliance, etc.). Next, an example of processing by the data processing system 10 according to the first embodiment will be described.

### Example 1.1

A flow of specific processing in Example 1.1 will be described. Each unit of the system described below is realized by the data processing apparatus 12 and the smart device 14. Also, the data processing apparatus 12 is referred to as a “server”, and the smart device 14 is referred to as a “terminal”.

A drive recorder system equipped with a conversational AI and realized by a server and a terminal will be described more specifically and in detail. This system includes a camera unit and a microphone unit mounted on the terminal, and a processing unit that operates on the server, to support the driver's safe driving.

First, a high-performance camera unit is mounted on the terminal and constantly monitors the driver's face. The camera unit uses image processing technology to detect, in real time, the blinking frequency, eye opening and closing time, gaze direction, head tilt, and the like. For example, if the driver blinks more than usual in one minute or closes their eyes for two seconds or more, it is recognized as a sign of drowsiness. Also, if the gaze is averted from the road or the head is tilted significantly to the left or right, it is detected as a sign of inattention. This allows the camera unit to grasp the driver's condition in detail and enables early detection of drowsiness and inattention.

As a specific algorithm for drowsiness detection by the camera unit, the processing unit executes the following steps. (1) A plurality of landmark points indicating contours of eyes are detected from an acquired face image. (2) An eye aspect ratio (EAR) is calculated based on a distance between an upper eyelid and a lower eyelid and a horizontal width of the eye. (3) When a state in which the calculated EAR falls below a predetermined threshold (for example, 0.2) continues for a predetermined number of frames (for example, 15 consecutive frames) or more, it is determined that the eyes are closed. This determination logic includes a function of dynamically calibrating the threshold based on a normal EAR distribution of an individual driver, and automatically corrects variations in determination accuracy due to individual differences such as presence or absence of glasses or eye size.

The camera unit may be configured by, for example, the camera 42 of the smart device 14.

Next, a high-sensitivity microphone unit is mounted on the terminal and collects in-vehicle audio. The microphone unit uses voice recognition technology to analyze changes in the driver's voice tone and manner of speaking. For example, if the driver's voice becomes lower than usual or the speaking speed slows down, it is recognized as a sign of fatigue. Also, the content of conversations in the vehicle is analyzed to determine whether the driver is feeling stressed. Furthermore, it is also possible to analyze the in-vehicle sound environment and detect abnormal sounds (for example, sudden braking sounds or collision sounds). This allows the microphone unit to grasp the driver's psychological state in detail and enables early detection of stress and fatigue.

The microphone unit may be configured by, for example, the reception device 38 (microphone 38B or the like) of the smart device 14.

These data are transmitted from the terminal to the server using high-speed communication technology. The processing unit on the server integrates the data acquired from the camera unit and the microphone unit and comprehensively evaluates the driver's condition. The processing unit uses a machine learning algorithm to analyze past driving data and learn the driver's driving pattern. For example, the system can learn that a specific driver is prone to drowsiness during a specific time period and can issue a warning in advance based on that information. Also, if the driver frequently performs sudden acceleration or sudden braking, the system can analyze that driving style and provide appropriate advice.

Furthermore, when drowsiness or dangerous driving is detected, the processing unit provides a voice warning to the driver. For example, the system provides messages such as “It seems you are feeling drowsy. We recommend taking a break” or “Please reduce your speed.” Also, when a sudden lane change or sudden acceleration is detected, the system can issue specific driving instructions such as “Please be careful when changing lanes.” This makes it possible to provide immediate feedback to the driver and promote safe driving.

Furthermore, the processing unit has a timestamp adjustment function of acquiring image data acquired from the camera unit and voice data acquired from the microphone unit asynchronously at different sampling rates, and synchronizing them on a common time axis. The processing unit concatenates a feature vector extracted from the image data (for example, displacement of facial landmark coordinates) and a feature vector extracted from the voice data (for example, Mel-frequency cepstral coefficients: MFCC), and inputs the concatenated vectors into a multimodal neural network, thereby identifying a minute state change of the driver (such as a correlation between a micro-expression and a trembling voice) which is difficult to detect with a single modality. With this configuration, it becomes possible to reduce false positives caused by environmental sounds or light reflection, which were processed as noise in the related art, and to efficiently allocate calculation resources.

The processing unit may be configured by, for example, the computer 22 (processor 28 or the like) of the data processing apparatus 12, or may be configured by the specific processing unit 290, the specific processing program 56, the data generation model 58, and the like.

Thus, the objective is to reduce the risk of traffic accidents and improve safety by having the terminal and the server cooperate to monitor the driver's condition in detail and take appropriate action. This system enables real-time data processing and feedback, and provides an effective means for supporting the driver's safe driving. Furthermore, since the system learns the driver's driving habits over time and can provide more accurate advice, it also contributes to the promotion of long-term safe driving.

### (System Configuration)

The system includes a camera unit, a microphone unit, a communication unit, a processing unit, and an output unit. The camera unit includes a high-performance camera for constantly monitoring the driver's face, and uses image processing technology to detect, in real time, the blinking frequency, eye opening and closing time, gaze direction, head tilt, and the like. For example, if the driver blinks more than usual in one minute or closes their eyes for two seconds or more, it is recognized as a sign of drowsiness. Also, if the gaze is averted from the road or the head is tilted significantly to the left or right, it is also detected as a sign of inattention. Furthermore, the camera unit can also capture changes in the driver's facial expression and detect changes in emotion. This allows the camera unit to grasp the driver's condition in detail and enables early detection of drowsiness and inattention.

The microphone unit includes a high-sensitivity microphone for collecting in-vehicle audio, and uses voice recognition technology to analyze changes in the driver's voice tone and manner of speaking. For example, if the driver's voice becomes lower than usual or the speaking speed slows down, it is recognized as a sign of fatigue. Also, the content of conversations in the vehicle is analyzed to determine whether the driver is feeling stressed. Furthermore, it is also possible to analyze the in-vehicle sound environment and detect abnormal sounds (for example, sudden braking sounds or collision sounds). The microphone unit enables early detection of stress and fatigue by grasping the driver's psychological state in detail.

The communication unit uses high-speed communication technology to transmit data from the terminal to the server. The communication unit transmits the data acquired from the camera unit and the microphone unit to the server, enabling real-time data processing. For example, it quickly transmits data regarding the driver's condition to the server and supports analysis by the processing unit. Also, the communication unit can receive feedback from the server to the terminal and provide information to the driver immediately. This allows the communication unit to smoothly perform information transmission for the entire system and enables real-time response.

The processing unit operates on the server and integrates the data acquired from the camera unit and the microphone unit to comprehensively evaluate the driver's condition. The processing unit uses a machine learning algorithm to analyze past driving data and learn the driver's driving pattern. For example, the system can learn that a specific driver is prone to drowsiness during a specific time period and can issue a warning in advance based on that information. Also, if the driver frequently performs sudden acceleration or sudden braking, the system can analyze that driving style and provide appropriate advice. Furthermore, since the processing unit learns the driver's driving habits and can provide more accurate advice, it also contributes to the promotion of long-term safe driving.

The output unit includes a voice output device for providing feedback from the processing unit to the driver. The output unit provides a voice warning to the driver when drowsiness or dangerous driving is detected. For example, it provides messages such as “It seems you are feeling drowsy. We recommend taking a break” or “Please reduce your speed.” Also, when a sudden lane change or sudden acceleration is detected, the system can issue specific driving instructions such as “Please be careful when changing lanes.” This allows the output unit to provide immediate feedback to the driver and makes it possible to promote safe driving.

The output unit may have a function of transmitting a direct control signal to a control system (CAN: Controller Area Network) of the vehicle in addition to feedback by voice. For example, when the processing unit detects “extreme drowsiness” or “loss of consciousness,” the processing unit transmits an emergency control signal instructing an ADAS (Advanced Driver-Assistance System) of the vehicle to turn on hazard lamps, retract a seatbelt (haptic warning), and stop on a road shoulder by gentle deceleration. This processing is executed as an interrupt request with high priority in parallel with dialogue processing by the generative AI, and resources are allocated with top priority by a scheduler of an OS.

Specific examples of prompt sentences to be read into the generative AI include “Design an image processing algorithm to detect driver drowsiness” and “Develop a voice recognition technology to analyze stress levels from in-vehicle audio.” These prompt sentences are used to clarify the technical requirements for each part of the system to function properly and to streamline the development process.

In a prompt generation process for the generative AI, the processing unit performs the following dynamic construction processing instead of simply embedding data in a fixed phrase. The processing unit determines a “Tone” parameter and an “Urgency” parameter of a prompt based on an emotion vector (for example, two-dimensional values of arousal and valence) output by the emotion identification model 59. For example, when the emotion vector indicates “high arousal and negative valence (panic state),” the processing unit adds a system instruction to the prompt to “use a short, assertive, and reassuring imperative form.” Thereby, the generative AI generates text that is immediately understandable in consideration of a cognitive load of the driver. This is executed at a speed (on the order of several milliseconds) that is temporally impossible for a human to input manually.

### (Implementation Steps)

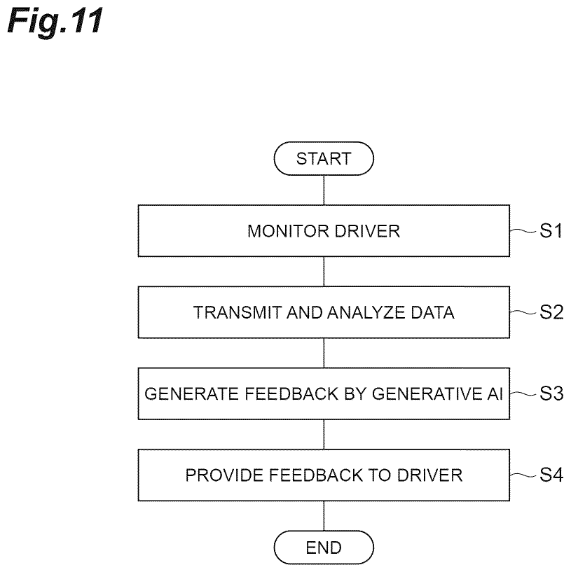

### Step 1: Driver Condition Monitoring (Refer to Step S1 of FIG. 11)

In this step, the driver's condition is monitored in real time using the camera unit and the microphone unit mounted on the terminal. The camera unit constantly monitors the driver's face and detects the blinking frequency, eye opening and closing time, gaze direction, head tilt, and the like. For example, if the driver blinks more than usual in one minute or closes their eyes for two seconds or more, it is recognized as a sign of drowsiness. The microphone unit collects in-vehicle audio and analyzes changes in the driver's voice tone and manner of speaking. For example, if the driver's voice becomes lower than usual or the speaking speed slows down, it is recognized as a sign of fatigue.

### Step 2: Data Transmission and Analysis (Refer to Step S2 of FIG. 11)

In this step, the data acquired from the camera unit and the microphone unit is transmitted to the server using the communication unit. The communication unit quickly transmits the data to the server using high-speed communication technology, enabling real-time data processing. The processing unit on the server integrates the received data and comprehensively evaluates the driver's condition. The processing unit uses a machine learning algorithm to analyze past driving data and learn the driver's driving pattern. For example, the system can learn that a specific driver is prone to drowsiness during a specific time period and can issue a warning in advance based on that information.

### Step 3: Advice Generation by Generative AI (Refer to Step S3 of FIG. 11)

In this step, advice to be provided to the driver is generated using a generative AI. The generative AI generates appropriate feedback based on the driver's condition analyzed by the processing unit. For example, it generates messages such as “It seems you are feeling drowsy. We recommend taking a break” or “Please reduce your speed.” Specific examples of prompt sentences to be read into the generative AI include “Generate appropriate advice to provide when driver drowsiness is detected” and “Generate specific driving instructions for when dangerous driving is detected.”

### Step 4: Provision of Feedback (Refer to Step S4 of FIG. 11)

In this step, the feedback generated by the generative AI is provided to the driver using the output unit. The output unit uses a voice output device to provide a real-time warning to the driver. For example, when drowsiness or dangerous driving is detected, it provides specific messages by voice, such as “It seems you are feeling drowsy. We recommend taking a break” or “Please reduce your speed.” This makes it possible to provide immediate feedback to the driver and promote safe driving.

### (Specific Use Case)

For example, a case where a driver on a long-distance drive uses the system will be described. The driver is scheduled to drive for a long time from early in the morning, and the system installs the terminal in the vehicle before departure. The camera unit constantly monitors the driver's face during driving and detects the blinking frequency and eye opening and closing time in real time. When several hours have passed since the driver started driving, the camera unit detects that the driver's blinking frequency has increased and the time their eyes are closed has become longer. As a result, the system determines that the driver is beginning to feel drowsy.

At the same time, the microphone unit collects in-vehicle audio and analyzes changes in the driver's voice tone and manner of speaking. It detects that the driver's voice is lower than usual and the speaking speed has slowed down, which is also determined as a sign of fatigue. These data are transmitted to the server via the communication unit and are integrally analyzed by the processing unit. The processing unit comprehensively evaluates the driver's condition and determines that drowsiness and fatigue are significant.

The generative AI generates advice to be provided to the driver based on this analysis result. For example, it generates a message such as “Signs of drowsiness and fatigue have been detected. For safety, we recommend taking a break at the next service area.” A specific example of a prompt sentence to be read into the generative AI is “Generate specific advice for a break to provide when driver drowsiness and fatigue are detected.”

The output unit provides the generated message to the driver by voice. This allows the driver to immediately recognize their own condition and take appropriate action for safe driving. In this way, the system can significantly improve safety in long-distance driving by monitoring the driver's condition in detail and providing appropriate feedback.

### Example 1.2

A flow of specific processing in Example 1.2 will be described. Each unit of the system described below is realized by the data processing apparatus 12 and the smart device 14. Also, the data processing apparatus 12 is referred to as a “server”, and the smart device 14 is referred to as a “terminal”.

This embodiment is a monitoring and optimization system for improving the safety and comfort of passengers in an autonomous vehicle, and includes a camera unit, a microphone unit, a sensor unit, a communication unit, a processing unit, and an output unit.

First, the camera unit is installed inside the vehicle and monitors the passengers' expressions and movements in real time. The camera unit uses a high-resolution camera to capture changes in the passengers' facial expressions and determines whether the passengers are feeling anxious or stressed. For example, if a passenger has an anxious expression, the system can provide information to give a sense of security, such as “The estimated time to destination is 10 minutes. Please be assured.” Furthermore, if a passenger is sleeping, it is also possible to set an alert to gently wake them up before arriving at the destination. The camera unit also detects the passenger's movements, and for example, if a passenger is not wearing a seatbelt, it can issue an alert to urge them to do so. This allows the camera unit to play an important role in ensuring the safety of the passengers.

Next, the microphone unit collects in-vehicle audio and analyzes the passengers' conversations and the sound environment. The microphone unit uses a high-sensitivity microphone to analyze changes in the passengers' voice tone and manner of speaking, and determines whether the passengers are feeling stressed. For example, if a passenger is asking a question about the destination, the AI provides an appropriate answer. For example, in response to the question “Where is the next stop?”, it provides a specific answer such as “The next stop is Central Station.” Also, if the in-vehicle sound environment is noisy, it provides a comfortable sound environment by utilizing a noise-canceling function, allowing the passengers to relax. Furthermore, the microphone unit can analyze the content of the passengers' conversations, and if a passenger has a specific request or complaint, it can take action in response.

Furthermore, the sensor unit is installed on the exterior of the vehicle and monitors the surrounding traffic and road conditions in detail. The sensor unit uses a laser sensor or a camera to accurately measure the distance to other vehicles and pedestrians, and provides driving instructions to the autonomous driving system to reduce the risk of collision. For example, if a vehicle in front stops suddenly, the system automatically decelerates and avoids a collision. Also, in bad weather, it can detect the slipperiness of the road surface and instruct operation at an appropriate speed. Furthermore, the sensor unit can recognize road signs and signals, and can provide information necessary for the operation of the vehicle. This allows the sensor unit to play an important role in supporting the safe operation of the vehicle.

These data are transmitted to a cloud server via the communication unit and are integrally analyzed by the processing unit. The communication unit quickly transmits the data to the server using high-speed communication technology, enabling real-time data processing. The processing unit uses a machine learning algorithm to analyze past operation data and learn the vehicle's operation pattern. This makes it possible to optimize the vehicle's operation efficiency and reduce energy consumption. For example, fuel consumption can be suppressed by choosing to operate during time periods with low traffic volume. Furthermore, the processing unit can generate optimal feedback according to the passenger's condition and take action to improve the passenger's comfort.

The output unit includes a voice output device for providing feedback from the processing unit to the passengers. The output unit provides the feedback generated by the generative AI to the passengers by voice. For example, if a passenger is feeling anxious, it provides a message such as “The estimated time to destination is 10 minutes. Please be assured.” Also, when a sudden lane change or sudden acceleration is detected, the system can issue specific driving instructions such as “Please be careful when changing lanes.” This allows the output unit to provide immediate feedback to the passengers and makes it possible to promote safe driving.

The risk of traffic accidents may be reduced and safety may be improved by having each unit cooperate to monitor the passenger's condition in detail and take appropriate action in order to improve the safety and comfort of an autonomous vehicle. Specific examples of prompt sentences to be read into the generative AI include “Infer emotion from the passenger's expression and generate appropriate feedback” and “Propose an optimal operation route according to the traffic situation.” This allows the AI to provide more accurate advice and optimize the operation of the vehicle.

### (System Configuration)

The system includes a camera unit, a microphone unit, a sensor unit, a communication unit, a processing unit, and an output unit. The camera unit includes a high-resolution camera installed inside the vehicle for monitoring the passengers' expressions and movements in real time. The camera unit captures changes in the passengers' facial expressions and determines whether the passengers are feeling anxious or stressed. For example, if a passenger has an anxious expression, the system can provide information to give a sense of security, such as “The estimated time to destination is 10 minutes. Please be assured.” Also, if a passenger is sleeping, it is also possible to set an alert to gently wake them up before arriving at the destination. Furthermore, the camera unit can detect the passenger's movements, and for example, if a passenger is not wearing a seatbelt, it can issue an alert to urge them to do so. This allows the camera unit to play an important role in ensuring the safety of the passengers.

The microphone unit includes a high-sensitivity microphone for collecting in-vehicle audio and analyzing the passengers' conversations and the sound environment. The microphone unit analyzes changes in the passengers' voice tone and manner of speaking, and determines whether the passengers are feeling stressed. For example, if a passenger is asking a question about the destination, the AI provides an appropriate answer. For example, in response to the question “Where is the next stop?”, it provides a specific answer such as “The next stop is Central Station.” Also, if the in-vehicle sound environment is noisy, it provides a comfortable sound environment by utilizing a noise-canceling function, allowing the passengers to relax. Furthermore, the microphone unit can analyze the content of the passengers' conversations, and if a passenger has a specific request or complaint, it can take action in response.

The sensor unit includes a laser sensor and a camera installed on the exterior of the vehicle for monitoring the surrounding traffic and road conditions in detail. The sensor unit accurately measures the distance to other vehicles and pedestrians, and provides driving instructions to the autonomous driving system to reduce the risk of collision. For example, if a vehicle in front stops suddenly, the system automatically decelerates and avoids a collision. Also, in bad weather, it can detect the slipperiness of the road surface and instruct operation at an appropriate speed. Furthermore, the sensor unit can recognize road signs and signals, and can provide information necessary for the operation of the vehicle. This allows the sensor unit to play an important role in supporting the safe operation of the vehicle.

The communication unit uses high-speed communication technology to transmit these data to a cloud server. The communication unit quickly transmits the data acquired from the camera unit, the microphone unit, and the sensor unit to the server, enabling real-time data processing. The communication unit also receives feedback from the server and provides appropriate instructions to each unit within the vehicle. This allows the communication unit to smoothly perform information transmission for the entire system and enables real-time response.

The processing unit operates on the server and integrally analyzes the received data. The processing unit uses a machine learning algorithm to analyze past operation data and learn the vehicle's operation pattern. This makes it possible to optimize the vehicle's operation efficiency and reduce energy consumption. For example, fuel consumption can be suppressed by choosing to operate during time periods with low traffic volume. Furthermore, the processing unit can generate optimal feedback according to the passenger's condition and take action to improve the passenger's comfort.

The output unit includes a voice output device for providing feedback from the processing unit to the passengers. The output unit provides the feedback generated by the generative AI to the passengers by voice. For example, if a passenger is feeling anxious, it provides a message such as “The estimated time to destination is 10 minutes. Please be assured.” Also, when a sudden lane change or sudden acceleration is detected, the system can issue specific driving instructions such as “Please be careful when changing lanes.” This allows the output unit to provide immediate feedback to the passengers and makes it possible to promote safe driving.

Specific examples of prompt sentences to be read into the generative AI include “Infer emotion from the passenger's expression and generate appropriate feedback” and “Propose an optimal operation route according to the traffic situation.” This allows the AI to provide more accurate advice and optimize the operation of the vehicle.

### (Implementation Steps)

### Step 1: Passenger Condition Monitoring

In this step, the passenger's condition is monitored in real time using the camera unit and the microphone unit. The camera unit uses a high-resolution camera installed inside the vehicle to capture the passenger's expressions and movements in detail. For example, if a passenger has an anxious expression, the system detects that expression and determines the passenger's emotional state. Also, if a passenger is sleeping, it is possible to set an alert to gently wake them up before arriving at the destination. The microphone unit collects in-vehicle audio and analyzes the passenger's conversations and the sound environment. For example, if a passenger is asking a question about the destination, the AI provides an appropriate answer. If the in-vehicle sound environment is noisy, it provides a comfortable sound environment by utilizing a noise-canceling function.

### Step 2: External Environment Monitoring

In this step, the external environment of the vehicle is monitored in detail using the sensor unit. The sensor unit uses a laser sensor or a camera to accurately measure the distance to other vehicles and pedestrians. For example, if a vehicle in front stops suddenly, the system automatically decelerates and avoids a collision. Also, in bad weather, it can detect the slipperiness of the road surface and instruct operation at an appropriate speed. Furthermore, the sensor unit recognizes road signs and signals, and provides information necessary for the operation of the vehicle.

### Step 3: Data Transmission and Analysis

In this step, the data acquired from the camera unit, the microphone unit, and the sensor unit is transmitted to a cloud server using the communication unit. The communication unit quickly transmits the data to the server using high-speed communication technology, enabling real-time data processing. The processing unit integrally analyzes the received data and learns the vehicle's operation pattern. This makes it possible to optimize the vehicle's operation efficiency and reduce energy consumption.

### Step 4: Feedback Generation by Generative AI

In this step, feedback to be provided to the passengers is generated using a generative AI. The generative AI generates optimal feedback according to the passenger's condition based on the data analyzed by the processing unit. For example, if a passenger is feeling anxious, it generates a message such as “The estimated time to destination is 10 minutes. Please be assured.” Specific examples of prompt sentences to be read into the generative AI include “Infer emotion from the passenger's expression and generate appropriate feedback” and “Propose an optimal operation route according to the traffic situation.”

### Step 5: Provision of Feedback

In this step, the feedback generated by the generative AI is provided to the passengers using the output unit. The output unit provides real-time feedback to the passengers using a voice output device. For example, when a sudden lane change or sudden acceleration is detected, the system can issue specific driving instructions such as “Please be careful when changing lanes.” This makes it possible to provide immediate feedback to the passengers and promote safe driving.

### (Specific Use Case)

For example, how the system functions in an autonomous vehicle making a long-distance trip will be described. The vehicle is traveling on a highway connecting cities, and the passengers are heading to their destination in a relaxed state. The camera unit constantly monitors the passengers' expressions and determines whether the passengers are relaxed or feeling anxious. If a passenger shows an anxious expression, the system generates a message such as “The estimated time to destination is 30 minutes. Please be assured” to give the passenger a sense of security.

The microphone unit collects in-vehicle audio and analyzes the passengers' conversations. If a passenger asks, “Where is the next stop?”, the AI provides a specific answer, “The next stop is a service area.” Also, if the in-vehicle sound environment is noisy, it adjusts the sound environment so that the passengers can be comfortable by utilizing a noise-canceling function.

The sensor unit monitors the external environment of the vehicle in detail and accurately measures the distance to other vehicles and pedestrians. If a vehicle in front stops suddenly, the system automatically decelerates and avoids a collision. Also, in bad weather, it detects the slipperiness of the road surface and instructs operation at an appropriate speed. Furthermore, it recognizes road signs and signals, and provides information necessary for the operation of the vehicle.

These data are transmitted to a cloud server via the communication unit and are integrally analyzed by the processing unit. The processing unit uses a machine learning algorithm to analyze past operation data and learn the vehicle's operation pattern. This makes it possible to optimize the vehicle's operation efficiency and reduce energy consumption. For example, fuel consumption can be suppressed by choosing to operate during time periods with low traffic volume.

The generative AI generates feedback to be provided to the passengers based on the analysis results. For example, if a passenger is feeling anxious, it generates a message such as “The estimated time to destination is 30 minutes. Please be assured.” Specific examples of prompt sentences to be read into the generative AI include “Infer emotion from the passenger's expression and generate appropriate feedback” and “Propose an optimal operation route according to the traffic situation.”

The output unit provides the generated feedback to the passengers by voice. This allows the passengers to immediately recognize their own condition and makes it possible to take action to promote safe driving. In this way, the system aims to improve the safety and comfort of an autonomous vehicle and also to enhance passenger satisfaction.

The specific processing unit 290 transmits a result of the specific processing to the smart device 14. In the smart device 14, the control unit 46A causes the output device 40 to output the result of the specific processing. The microphone 38B acquires voice indicating a user input for the result of the specific processing. The control unit 46A transmits voice data indicating the user input acquired by the microphone 38B to the data processing apparatus 12. In the data processing apparatus 12, the specific processing unit 290 acquires the voice data.

The data generation model 58 is a so-called generative AI (Artificial Intelligence). An example of the data generation model 58 includes a generative AI such as ChatGPT (registered trademark) (Internet search <URL: https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The specific processing unit 290 performs the above-described specific processing while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes AIs other than generative AI. Als other than generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naïve Bayes, and can perform various processes, but is not limited to such examples. Also, the AI may be an AI agent. Also, when the processing of each unit described above is performed by an AI, the processing is partially or entirely performed by the AI, but is not limited to such examples. Also, a process implemented by an AI including a generative AI may be replaced with a rule-based process, and a rule-based process may be replaced with a process implemented by an AI including a generative AI.

The data generation model 58 includes a Large Language Model (LLM) based on a Transformer architecture, and infers by weighting not only a most recent user utterance but also a conversation history of a past predetermined period (for example, from a start of driving to the present) and a time-series change (context) of sensor data, particularly using a self-attention mechanism. Thereby, intention understanding in line with context becomes possible, not just for sudden words. In addition, the model is enhanced by fine-tuning or RAG (Retrieval-Augmented Generation) technology using a dataset related to a specific domain (driving safety, traffic laws), and has a structure that outputs professional advice in line with traffic conditions, which cannot be generated by a general chatbot.

Also, the processing by the data processing system 10 described above is executed by the specific processing unit 290 of the data processing apparatus 12 or the control unit 46A of the smart device 14, but may also be executed by the specific processing unit 290 of the data processing apparatus 12 and the control unit 46A of the smart device 14. Also, the specific processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the specific processing unit 290 of the data processing apparatus 12. For example, an acquisition unit acquires step count data using the camera 42 or the communication I/F 44 of the smart device 14, and the data is processed by the specific processing unit 290 of the data processing apparatus 12. For example, an analysis unit is realized by the specific processing unit 290 of the data processing apparatus 12, and analyzes data from the collection unit and the acquisition unit. For example, a generation unit is realized by the specific processing unit 290 of the data processing apparatus 12, and generates a cooking menu using a generative AI. For example, a provision unit is realized by the output device 40 of the smart device 14 or the specific processing unit 290 of the data processing apparatus 12, and provides the generated cooking menu to a user. The correspondence relationship between each unit and the device or the control unit is not limited to the above-described example, and various changes are possible.

An example form in which the specific processing is performed by the data processing apparatus 12 has been described, but the technology of the present disclosure is not limited to this, and the specific processing may be performed by the smart device 14.

### Second Embodiment

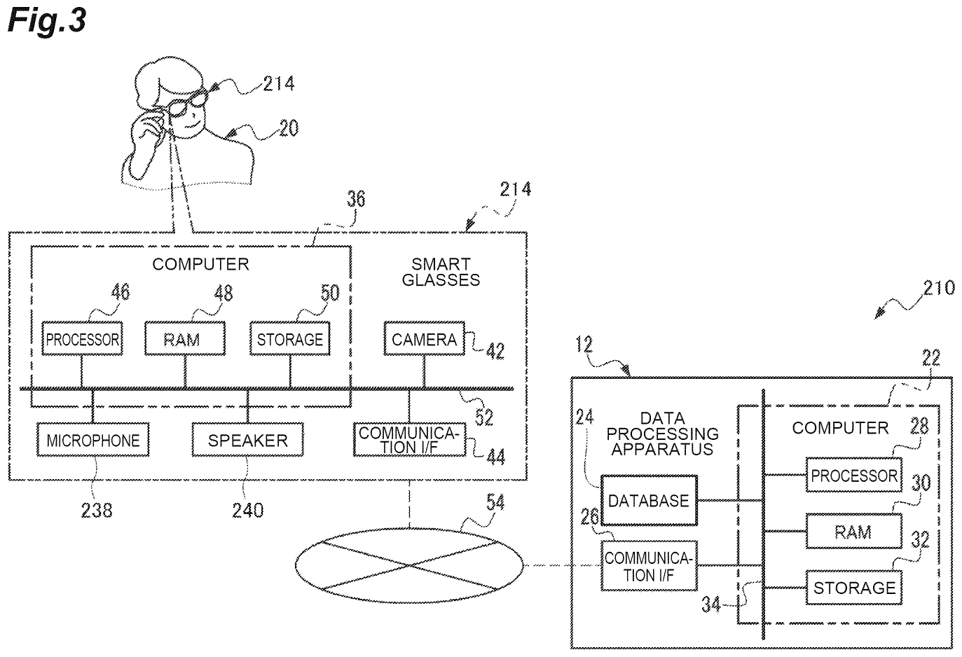

FIG. 3 illustrates an example of a configuration of a data processing system 210 according to a second embodiment.

As illustrated in FIG. 3, the data processing system 210 includes a data processing apparatus 12 and smart glasses 214. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The smart glasses 214 include a computer 36, a microphone 238, a speaker 240, a camera 42, and a communication I/F 44. The computer 36 includes a processor 46, a RAM 48, and a storage 50. The processor 46, the RAM 48, and the storage 50 are connected to a bus 52. Also, the microphone 238, the speaker 240, and the camera 42 are also connected to the bus 52.

The microphone 238 receives an instruction or the like from a user 20 by receiving voice uttered by the user 20. The microphone 238 captures the voice uttered by the user 20, converts the captured voice into voice data, and outputs the voice data to the processor 46. The speaker 240 outputs voice in accordance with an instruction from the processor 46.

The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted, and images the surroundings of the user 20 (for example, an imaging range defined by an angle of view corresponding to the width of the field of view of a general person with normal vision).

The communication I/F 44 is connected to the network 54. The communication I/Fs 44 and 26 manage exchange of various information between the processor 46 and the processor 28 via the network 54. The exchange of various information between the processor 46 and the processor 28 using the communication I/Fs 44 and 26 is performed in a secure state.

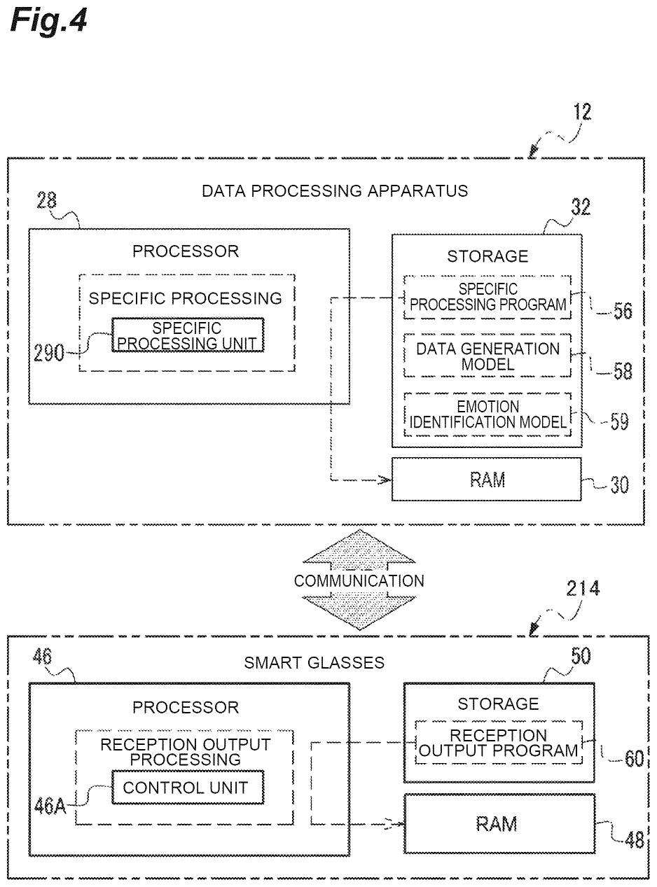

FIG. 4 illustrates an example of main functions of the data processing apparatus 12 and the smart glasses 214. As illustrated in FIG. 4, in the data processing apparatus 12, specific processing is performed by the processor 28. A specific processing program 56 is stored in the storage 32.

The specific processing program 56 is an example of a “program” according to the technology of the present disclosure. The processor 28 reads the specific processing program 56 from the storage 32 and executes the read specific processing program 56 on the RAM 30. The specific processing is realized by the processor 28 operating as a specific processing unit 290 in accordance with the specific processing program 56 executed on the RAM 30.

A data generation model 58 and an emotion identification model 59 are stored in the storage 32. The data generation model 58 and the emotion identification model 59 are used by the specific processing unit 290. The specific processing unit 290 can estimate a user's emotion using the emotion identification model 59 and perform specific processing using the user's emotion. In an emotion estimation function (emotion identification function) using the emotion identification model 59, various estimations and predictions regarding the user's emotion, including estimation and prediction of the user's emotion, are performed, but is not limited to such examples. Also, the estimation and prediction of emotion include, for example, analysis (analytics) of emotion and the like.

In the smart glasses 214, reception output processing is performed by the processor 46. A reception output program 60 is stored in the storage 50. The processor 46 reads the reception output program 60 from the storage 50 and executes the read reception output program 60 on the RAM 48. The reception output processing is realized by the processor 46 operating as a control unit 46A in accordance with the reception output program 60 executed on the RAM 48. Note that the smart glasses 214 can also have a data generation model and an emotion identification model similar to the data generation model 58 and the emotion identification model 59, and perform processing similar to that of the specific processing unit 290 using these models.

Next, specific processing by the specific processing unit 290 of the data processing apparatus 12 will be described. Each unit of the system described below is realized by the data processing apparatus 12 and the smart glasses 214. In the following description, the data processing apparatus 12 is referred to as a “server”, and the smart glasses 214 are referred to as a “terminal”.

### Example 2.1

Since the flow of the specific processing is the same as that in Example 1.1 described in the first embodiment, a description thereof is omitted.

### Example 2.2

Since the flow of the specific processing is the same as that in Example 1.2 described in the first embodiment, a description thereof is omitted.

The specific processing unit 290 transmits a result of the specific processing to the smart glasses 214. In the smart glasses 214, the control unit 46A causes the speaker 240 to output the result of the specific processing. The microphone 238 acquires voice indicating a user input for the result of the specific processing. The control unit 46A transmits voice data indicating the user input acquired by the microphone 238 to the data processing apparatus 12. In the data processing apparatus 12, the specific processing unit 290 acquires the voice data.

The data generation model 58 is a so-called generative AI (Artificial Intelligence). An example of the data generation model 58 includes a generative AI such as ChatGPT (registered trademark) (Internet search <URL: https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The specific processing unit 290 performs the above-described specific processing while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes Als other than generative AI. Als other than generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but is not limited to such examples. Also, the AI may be an AI agent. Also, when the processing of each unit described above is performed by an AI, the processing is partially or entirely performed by the AI, but is not limited to such examples. Also, a process implemented by an AI including a generative AI may be replaced with a rule-based process, and a rule-based process may be replaced with a process implemented by an AI including a generative AI.

Also, the processing by the data processing system 10 described above is executed by the specific processing unit 290 of the data processing apparatus 12 or the control unit 46A of the smart device 14, but may also be executed by the specific processing unit 290 of the data processing apparatus 12 and the control unit 46A of the smart device 14. Also, the specific processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the specific processing unit 290 of the data processing apparatus 12. For example, an acquisition unit acquires step count data using the camera 42 or the communication I/F 44 of the smart device 14, and the data is processed by the specific processing unit 290 of the data processing apparatus 12. For example, an analysis unit is realized by the specific processing unit 290 of the data processing apparatus 12, and analyzes data from the collection unit and the acquisition unit. For example, a generation unit is realized by the specific processing unit 290 of the data processing apparatus 12, and generates a cooking menu using a generative AI. For example, a provision unit is realized by the output device 40 of the smart device 14 or the specific processing unit 290 of the data processing apparatus 12, and provides the generated cooking menu to a user. The correspondence relationship between each unit and the device or the control unit is not limited to the above-described example, and various changes are possible.

An example form in which the specific processing is performed by the data processing apparatus 12 has been described, but the technology of the present disclosure is not limited to this, and the specific processing may be performed by the smart glasses 214.

### Third Embodiment

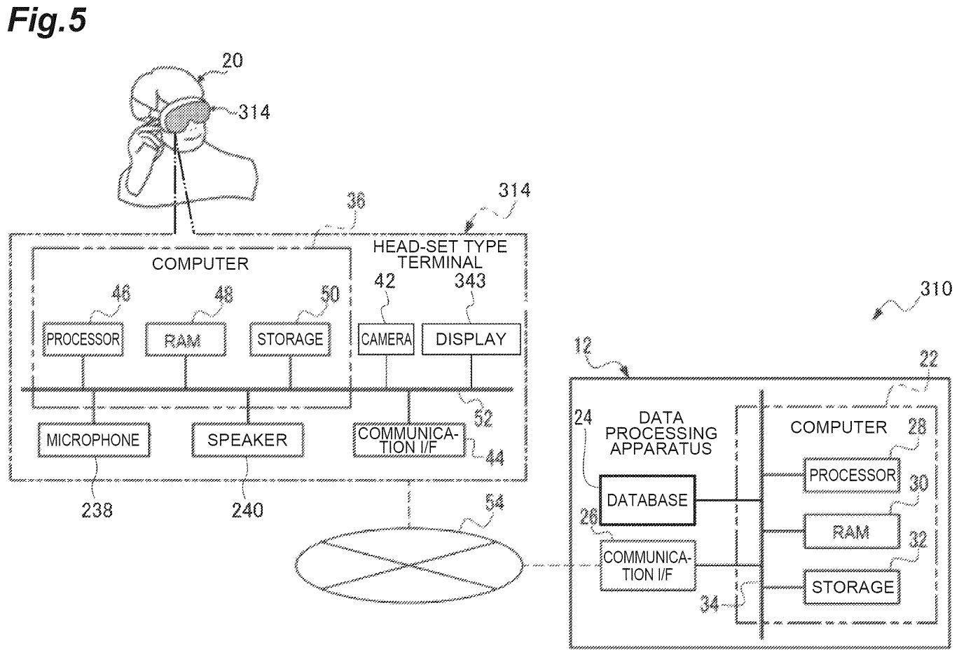

FIG. 5 illustrates an example of a configuration of a data processing system 310 according to a third embodiment.

As illustrated in FIG. 5, the data processing system 310 includes a data processing apparatus 12 and a headset-type terminal 314. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The headset-type terminal 314 includes a computer 36, a microphone 238, a speaker 240, a camera 42, a communication I/F 44, and a display 343. The computer 36 includes a processor 46, a RAM 48, and a storage 50. The processor 46, the RAM 48, and the storage 50 are connected to a bus 52. Also, the microphone 238, the speaker 240, the camera 42, and the display 343 are also connected to the bus 52.

The microphone 238 receives an instruction or the like from a user 20 by receiving voice uttered by the user 20. The microphone 238 captures the voice uttered by the user 20, converts the captured voice into voice data, and outputs the voice data to the processor 46. The speaker 240 outputs voice in accordance with an instruction from the processor 46.

The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted, and images the surroundings of the user 20 (for example, an imaging range defined by an angle of view corresponding to the width of the field of view of a general person with normal vision).

The communication I/F 44 is connected to the network 54. The communication I/Fs 44 and 26 manage exchange of various information between the processor 46 and the processor 28 via the network 54. The exchange of various information between the processor 46 and the processor 28 using the communication I/Fs 44 and 26 is performed in a secure state.

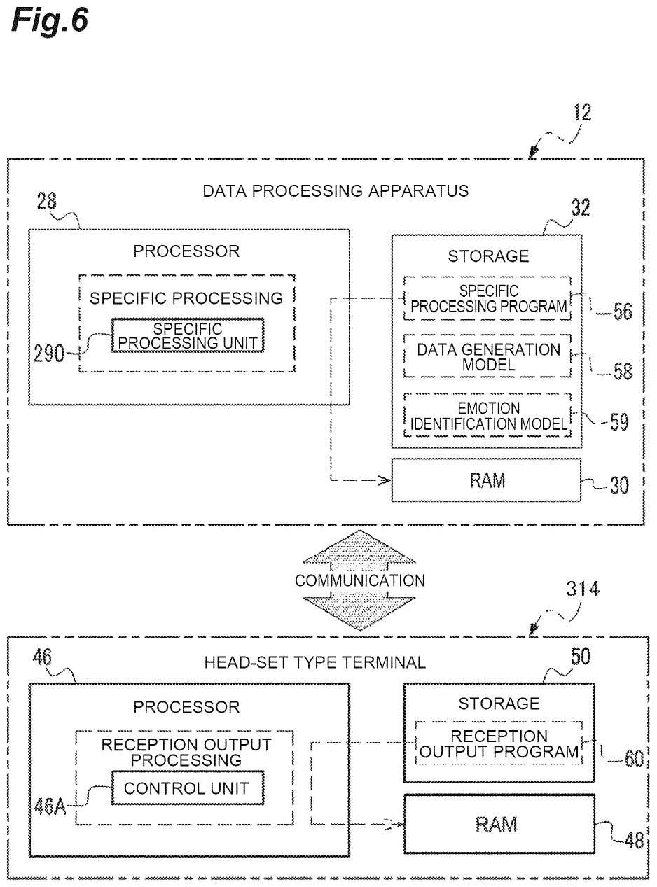

FIG. 6 illustrates an example of main functions of the data processing apparatus 12 and the headset-type terminal 314. As illustrated in FIG. 6, in the data processing apparatus 12, specific processing is performed by the processor 28. A specific processing program 56 is stored in the storage 32.

The specific processing program 56 is an example of a “program” according to the technology of the present disclosure. The processor 28 reads the specific processing program 56 from the storage 32 and executes the read specific processing program 56 on the RAM 30. The specific processing is realized by the processor 28 operating as a specific processing unit 290 in accordance with the specific processing program 56 executed on the RAM 30.

A data generation model 58 and an emotion identification model 59 are stored in the storage 32. The data generation model 58 and the emotion identification model 59 are used by the specific processing unit 290.

In the headset-type terminal 314, reception output processing is performed by the processor 46. A reception output program 60 is stored in the storage 50. The processor 46 reads the reception output program 60 from the storage 50 and executes the read reception output program 60 on the RAM 48. The reception output processing is realized by the processor 46 operating as a control unit 46A in accordance with the reception output program 60 executed on the RAM 48.

Next, specific processing by the specific processing unit 290 of the data processing apparatus 12 will be described. Each unit of the system described below is realized by the data processing apparatus 12 and the headset-type terminal 314. In the following description, the data processing apparatus 12 is referred to as a “server”, and the headset-type terminal 314 is referred to as a “terminal”.

### Example 3.1

Since the flow of the specific processing is the same as that in Example 1.1 described in the first embodiment, a description thereof is omitted.

### Example 3.2

Since the flow of the specific processing is the same as that in Example 1.2 described in the first embodiment, a description thereof is omitted.

The specific processing unit 290 transmits a result of the specific processing to the headset-type terminal 314. In the headset-type terminal 314, the control unit 46A causes the speaker 240 and the display 343 to output the result of the specific processing. The microphone 238 acquires voice indicating a user input for the result of the specific processing. The control unit 46A transmits voice data indicating the user input acquired by the microphone 238 to the data processing apparatus 12. In the data processing apparatus 12, the specific processing unit 290 acquires the voice data.

The data generation model 58 is a so-called generative AI (Artificial Intelligence). An example of the data generation model 58 includes a generative AI such as ChatGPT (registered trademark) (Internet search <URL: https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The specific processing unit 290 performs the above-described specific processing while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes AIs other than generative AI. Als other than generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but is not limited to such examples. Also, the AI may be an AI agent. Also, when the processing of each unit described above is performed by an AI, the processing is partially or entirely performed by the AI, but is not limited to such examples. Also, a process implemented by an AI including a generative AI may be replaced with a rule-based process, and a rule-based process may be replaced with a process implemented by an AI including a generative AI.

Also, the processing by the data processing system 10 described above is executed by the specific processing unit 290 of the data processing apparatus 12 or the control unit 46A of the smart device 14, but may also be executed by the specific processing unit 290 of the data processing apparatus 12 and the control unit 46A of the smart device 14. Also, the specific processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the specific processing unit 290 of the data processing apparatus 12. For example, an acquisition unit acquires step count data using the camera 42 or the communication I/F 44 of the smart device 14, and the data is processed by the specific processing unit 290 of the data processing apparatus 12. For example, an analysis unit is realized by the specific processing unit 290 of the data processing apparatus 12, and analyzes data from the collection unit and the acquisition unit. For example, a generation unit is realized by the specific processing unit 290 of the data processing apparatus 12, and generates a cooking menu using a generative AI. For example, a provision unit is realized by the output device 40 of the smart device 14 or the specific processing unit 290 of the data processing apparatus 12, and provides the generated cooking menu to a user. The correspondence relationship between each unit and the device or the control unit is not limited to the above-described example, and various changes are possible.

An example form in which the specific processing is performed by the data processing apparatus 12 has been described, but the technology of the present disclosure is not limited to this, and the specific processing may be performed by the headset-type terminal 314.

### Fourth Embodiment

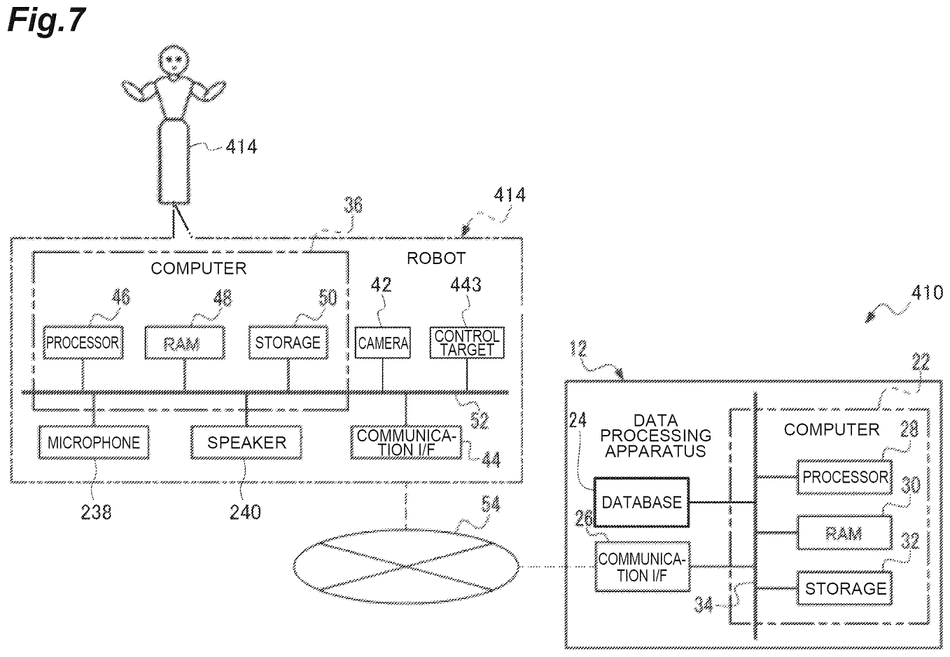

FIG. 7 illustrates an example of a configuration of a data processing system 410 according to a fourth embodiment.

As illustrated in FIG. 7, the data processing system 410 includes a data processing apparatus 12 and a robot 414. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The robot 414 includes a computer 36, a microphone 238, a speaker 240, a camera 42, a communication I/F 44, and a control target 443. The computer 36 includes a processor 46, a RAM 48, and a storage 50. The processor 46, the RAM 48, and the storage 50 are connected to a bus 52. Also, the microphone 238, the speaker 240, the camera 42, and the control target 443 are also connected to the bus 52.

The microphone 238 receives an instruction or the like from a user 20 by receiving voice uttered by the user 20. The microphone 238 captures the voice uttered by the user 20, converts the captured voice into voice data, and outputs the voice data to the processor 46. The speaker 240 outputs voice in accordance with an instruction from the processor 46.

The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted, and images the surroundings of the user 20 (for example, an imaging range defined by an angle of view corresponding to the width of the field of view of a general person with normal vision).

The communication I/F 44 is connected to the network 54. The communication I/Fs 44 and 26 manage exchange of various information between the processor 46 and the processor 28 via the network 54. The exchange of various information between the processor 46 and the processor 28 using the communication I/Fs 44 and 26 is performed in a secure state.

The control target 443 includes a display device, an LED of an eye part, and motors that drive an arm, a hand, a leg, and the like. The posture and gestures of the robot 414 are controlled by controlling the motors of the arm, hand, leg, and the like. A part of the emotions of the robot 414 can be expressed by controlling these motors. Also, the facial expression of the robot 414 can also be expressed by controlling the light emission state of the LED of the eye part of the robot 414.

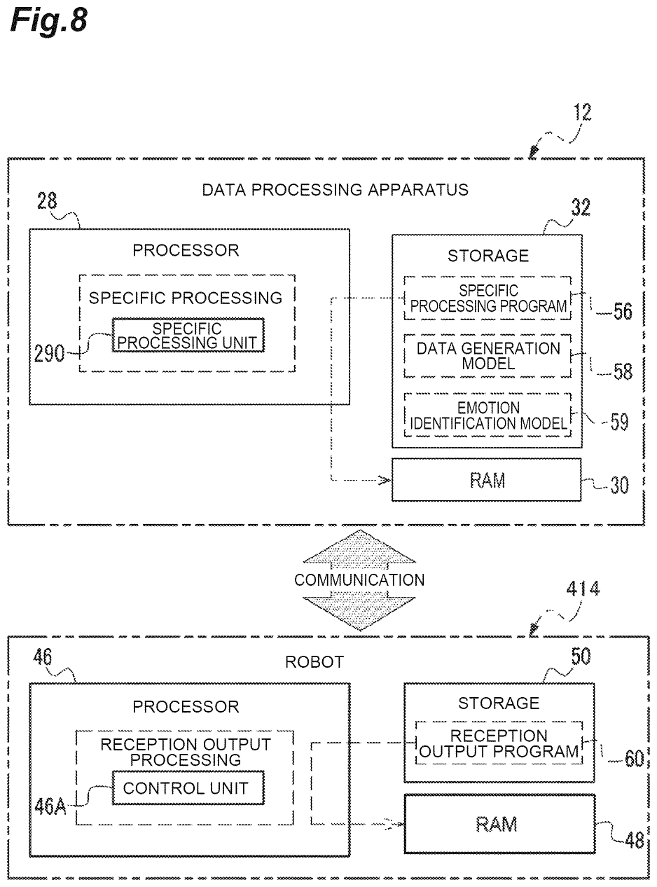

FIG. 8 illustrates an example of main functions of the data processing apparatus 12 and the robot 414. As illustrated in FIG. 8, in the data processing apparatus 12, specific processing is performed by the processor 28. A specific processing program 56 is stored in the storage 32.

The specific processing program 56 is an example of a “program” according to the technology of the present disclosure. The processor 28 reads the specific processing program 56 from the storage 32 and executes the read specific processing program 56 on the RAM 30. The specific processing is realized by the processor 28 operating as a specific processing unit 290 in accordance with the specific processing program 56 executed on the RAM 30.

A data generation model 58 and an emotion identification model 59 are stored in the storage 32. The data generation model 58 and the emotion identification model 59 are used by the specific processing unit 290.

In the robot 414, reception output processing is performed by the processor 46. A reception output program 60 is stored in the storage 50. The processor 46 reads the reception output program 60 from the storage 50 and executes the read reception output program 60 on the RAM 48. The reception output processing is realized by the processor 46 operating as a control unit 46A in accordance with the reception output program 60 executed on the RAM 48.

Next, specific processing by the specific processing unit 290 of the data processing apparatus 12 will be described. Each unit of the system described below is realized by the data processing apparatus 12 and the robot 414. In the following description, the data processing apparatus 12 is referred to as a “server”, and the robot 414 is referred to as a “terminal”.

### Example 4.1

Since the flow of the specific processing is the same as that in Example 1.1 described in the first embodiment, a description thereof is omitted.

### Example 4.2

Since the flow of the specific processing is the same as that in Example 1.2 described in the first embodiment, a description thereof is omitted.

The specific processing unit 290 transmits a result of the specific processing to the robot 414. In the robot 414, the control unit 46A causes the speaker 240 and the control target 443 to output the result of the specific processing. The microphone 238 acquires voice indicating a user input for the result of the specific processing. The control unit 46A transmits voice data indicating the user input acquired by the microphone 238 to the data processing apparatus 12. In the data processing apparatus 12, the specific processing unit 290 acquires the voice data.

The data generation model 58 is a so-called generative AI (Artificial Intelligence). An example of the data generation model 58 includes a generative AI such as ChatGPT (registered trademark) (Internet search <URL: https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The specific processing unit 290 performs the above-described specific processing while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes Als other than generative AI. AIs other than generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but is not limited to such examples. Also, the AI may be an AI agent. Also, when the processing of each unit described above is performed by an AI, the processing is partially or entirely performed by the AI, but is not limited to such examples. Also, a process implemented by an AI including a generative AI may be replaced with a rule-based process, and a rule-based process may be replaced with a process implemented by an AI including a generative AI.

Also, the processing by the data processing system 10 described above is executed by the specific processing unit 290 of the data processing apparatus 12 or the control unit 46A of the smart device 14, but may also be executed by the specific processing unit 290 of the data processing apparatus 12 and the control unit 46A of the smart device 14. Also, the specific processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the specific processing unit 290 of the data processing apparatus 12. For example, an acquisition unit acquires step count data using the camera 42 or the communication I/F 44 of the smart device 14, and the data is processed by the specific processing unit 290 of the data processing apparatus 12. For example, an analysis unit is realized by the specific processing unit 290 of the data processing apparatus 12, and analyzes data from the collection unit and the acquisition unit. For example, a generation unit is realized by the specific processing unit 290 of the data processing apparatus 12, and generates a cooking menu using a generative AI. For example, a provision unit is realized by the output device 40 of the smart device 14 or the specific processing unit 290 of the data processing apparatus 12, and provides the generated cooking menu to a user. The correspondence relationship between each unit and the device or the control unit is not limited to the above-described example, and various changes are possible.

An example form in which the specific processing is performed by the data processing apparatus 12 has been described, but the technology of the present disclosure is not limited to this, and the specific processing may be performed by the robot 414.

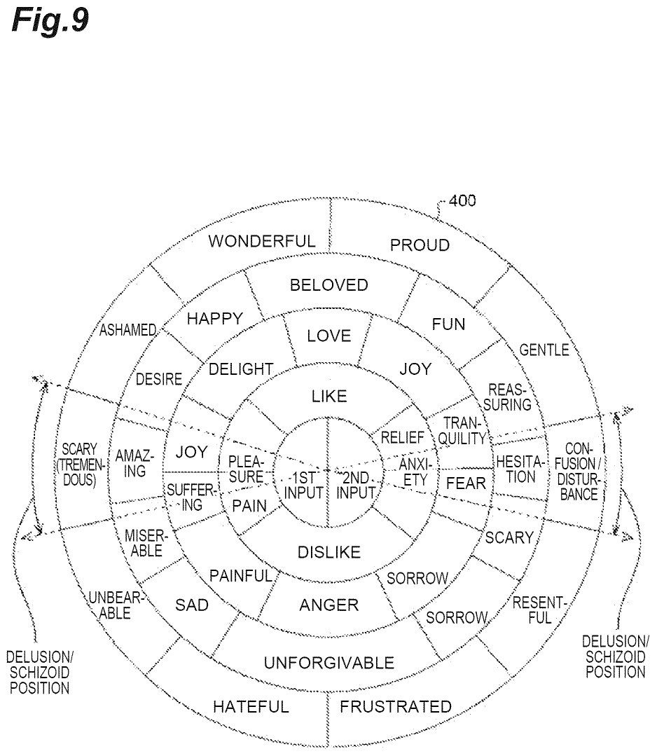

Note that the emotion identification model 59 as an emotion engine may determine a user's emotion according to a specific mapping. For example, the emotion identification model 59 may determine the user's emotion according to an emotion map (see FIG. 9), which is a specific mapping. Also, the emotion identification model 59 may similarly determine the robot's emotion, and the specific processing unit 290 may perform specific processing using the robot's emotion.

FIG. 9 is a diagram illustrating an emotion map 400 on which a plurality of emotions are mapped. In the emotion map 400, emotions are arranged in concentric circles radiating from the center. The closer to the center of the concentric circles, the more primitive the state of the emotion is arranged. On the outer side of the concentric circles, emotions representing states and actions arising from a state of mind are arranged. Emotion is a concept that also includes affect and mental states. On the left side of the concentric circles, emotions generated from reactions that generally occur in the brain are arranged. On the right side of the concentric circles, emotions that are generally induced by situational judgment are arranged. In the upward and downward directions of the concentric circles, emotions that are generated from reactions that generally occur in the brain and are induced by situational judgment are arranged. Also, on the upper side of the concentric circles, “pleasant” emotions are arranged, and on the lower side, “unpleasant” emotions are arranged. In this way, in the emotion map 400, a plurality of emotions are mapped based on the structure in which emotions are generated, and emotions that are likely to occur at the same time are mapped close to each other.

These emotions are distributed in the 3 o'clock direction of the emotion map 400, and usually go back and forth between relief and anxiety. In the right half of the emotion map 400, situational awareness is superior to internal sensations, resulting in a calm impression.

Since the inside of the emotion map 400 represents the inside of the mind and the outside of the emotion map 400 represents actions, the further one goes to the outside of the emotion map 400, the more visible (manifested in action) the emotion becomes.

Here, human emotions are based on various balances such as posture and blood sugar levels, and show a state of unpleasantness when those balances move away from the ideal, and a state of pleasantness when they approach the ideal. In robots, automobiles, motorcycles, and the like as well, emotions can be created based on various balances such as posture and remaining battery level, so as to show a state of unpleasantness when those balances move away from the ideal, and a state of pleasantness when they approach the ideal. The emotion map may be generated based on, for example, Dr. Mitsuyoshi's emotion map (Research on a speech emotion recognition and brain physiological signal analysis system of affect, Tokushima University, doctoral dissertation: https://ci.nii.ac.jp/naid/500000375379). In the left half of the emotion map, emotions belonging to a region called “reaction” where sensation is dominant are arranged. Also, in the right half of the emotion map, emotions belonging to a region called “situation” where situational awareness is dominant are arranged.

In the emotion map, two emotions that promote learning are defined. One is an emotion around the middle of negative “remorse” and “reflection” on the situation side. That is, it is when a negative emotion such as “I never want to feel this way again” or “I don't want to be scolded anymore” arises in the robot. The other is an emotion around positive “desire” on the reaction side. That is, it is when there is a positive feeling such as “I want more” or “I want to know more”.

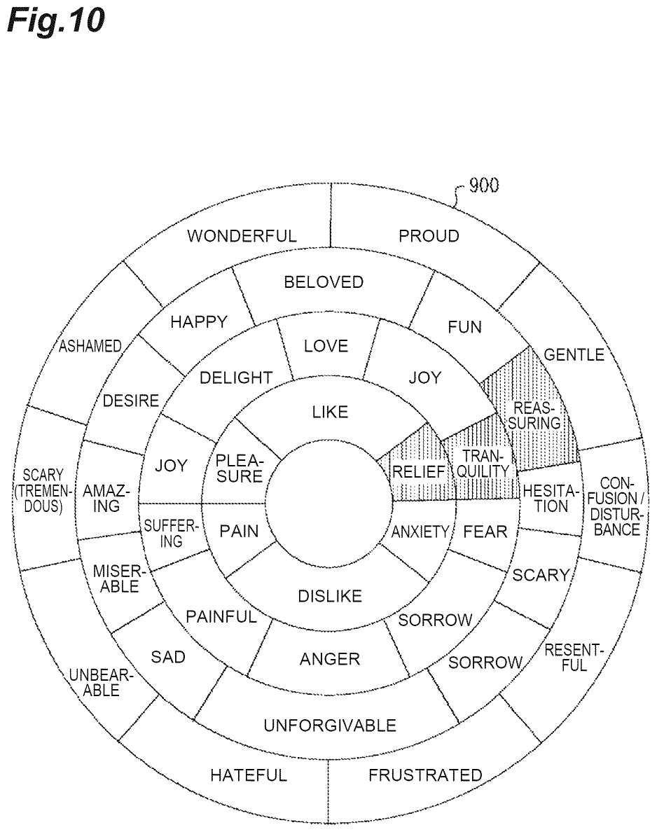

The emotion identification model 59 inputs a user input into a pre-trained neural network, acquires an emotion value indicating each emotion shown in the emotion map 400, and determines the user's emotion. This neural network is pre-trained based on a plurality of learning data that are combinations of user inputs and emotion values indicating each emotion shown in the emotion map 400. Also, this neural network is trained such that emotions arranged close to each other have close values, as in the emotion map 900 shown in FIG. 10. FIG. 10 shows an example in which a plurality of emotions, “relief,” “peace of mind,” and “reassured,” have close emotion values.

Determination of an emotion value by the emotion identification model 59 is performed by converting input biological signals (facial expression, voice) into a vector in a multidimensional space and calculating a cosine similarity with a centroid vector of each emotion class defined on the emotion map 400 shown in FIG. 9. The processing unit not only identifies an emotion class with the highest similarity but also calculates probabilities of belonging to a plurality of emotion classes, and expresses the result as a mixed emotion (for example, “anxiety” and “expectation”). This vector operation processing is executed in parallel on a processor (GPU or the like) specialized for matrix operations to ensure real-time performance.

Although the system according to the present disclosure has been described above mainly with respect to the functions of the data processing apparatus 12, the system according to the present disclosure is not necessarily implemented in a server. The system according to the present disclosure may be implemented as a general information processing system. The present disclosure may be implemented as, for example, a software program that runs on a personal computer, or an application that runs on a smartphone or the like. The method according to the present disclosure may be provided to a user in a Saas (Software as a Service) format.

An example form in which the specific processing is performed by one computer 22 has been described, but the technology of the present disclosure is not limited to this, and distributed processing for the specific processing may be performed by a plurality of computers including the computer 22. For example, the data generation model 58 may be provided in an external device of the data processing apparatus 12, and the external device may generate data according to the input data.

An example form in which the specific processing program 56 is stored in the storage 32 has been described, but the technology of the present disclosure is not limited to this. For example, the specific processing program 56 may be stored in a portable computer-readable non-transitory storage medium such as a USB (Universal Serial Bus) memory. The specific processing program 56 stored in the non-transitory storage medium is installed in the computer 22 of the data processing apparatus 12. The processor 28 executes the specific processing according to the specific processing program 56.

Also, the specific processing program 56 may be stored in a storage device such as a server connected to the data processing apparatus 12 via the network 54, and the specific processing program 56 may be downloaded in response to a request from the data processing apparatus 12 and installed in the computer 22.

Note that it is not necessary to store all of the specific processing program 56 in a storage device such as a server connected to the data processing apparatus 12 via the network 54, or to store all of the specific processing program 56 in the storage 32, and a part of the specific processing program 56 may be stored.

As hardware resources for executing the specific processing, various processors shown below can be used. Examples of the processor include a CPU, which is a general-purpose processor that functions as a hardware resource for executing the specific processing by executing software, that is, a program. Also, examples of the processor include a dedicated electric circuit, which is a processor having a circuit configuration specifically designed to execute specific processing, such as an FPGA (Field-Programmable Gate Array), a PLD (Programmable Logic Device), or an ASIC (Application Specific Integrated Circuit). A memory is built in or connected to any of the processors, and any of the processors executes the specific processing by using the memory.

The hardware resource that executes the specific processing may be configured by one of these various processors, or may be configured by a combination of two or more processors of the same type or different types (for example, a combination of a plurality of FPGAs, or a combination of a CPU and an FPGA). Also, the hardware resource that executes the specific processing may be one processor.

As an example of a configuration with one processor, first, there is a form in which one processor is configured by a combination of one or more CPUs and software, and this processor functions as a hardware resource for executing the specific processing. Second, there is a form in which a processor that realizes the functions of an entire system including a plurality of hardware resources for executing the specific processing with one IC chip, as represented by an SoC (System-on-a-chip) or the like, is used. In this way, the specific processing is realized using one or more of the various processors described above as hardware resources.

Furthermore, as a hardware structure of these various processors, an electric circuit in which circuit elements such as semiconductor elements are combined can be used. Also, the specific processing described above is merely an example. Therefore, it goes without saying that unnecessary steps may be deleted, new steps may be added, or the processing order may be changed within a scope that does not depart from the gist.

The description and illustrations shown above are detailed descriptions of the parts related to the technology of the present disclosure, and are merely an example of the technology of the present disclosure. For example, the description regarding the above-described configuration, function, operation, and effect is a description regarding an example of the configuration, function, operation, and effect of the part related to the technology of the present disclosure. Therefore, it goes without saying that unnecessary parts may be deleted, new elements may be added, or replacements may be made to the description and illustrations shown above within a scope that does not depart from the gist of the technology of the present disclosure. Also, in order to avoid confusion and facilitate understanding of the parts related to the technology of the present disclosure, in the description and illustrations shown above, descriptions regarding common general technical knowledge and the like that do not require particular explanation for enabling the implementation of the technology of the present disclosure are omitted.

All documents, patent applications, and technical standards described in this specification are incorporated herein by reference to the same extent as if each individual document, patent application, and technical standard were specifically and individually indicated to be incorporated by reference.

It is to be understood that not all aspects, advantages and features described herein may necessarily be achieved by, or included in, any one particular example. Indeed, having described and illustrated various examples herein, it should be apparent that other examples may be modified in arrangement and detail.

A monitoring system for an autonomous vehicle, comprising a camera unit, a microphone unit, a sensor unit, a communication unit, a processing unit, and an output unit, wherein the camera unit has a function of monitoring a passenger's expression and movements in real time and detecting the passenger's emotional state, the microphone unit has a function of collecting in-vehicle audio and analyzing the passenger's conversation and sound environment, the sensor unit has a function of monitoring the external situation of the vehicle and measuring the distance to other vehicles and pedestrians, the communication unit has a function of transmitting these data to a cloud server, the processing unit has a function of integrally analyzing the received data and generating an instruction for optimizing the operating state of the vehicle, and the output unit has a function of providing the generated instruction to the passenger by voice.

In some examples, the processing unit has a function of optimizing operation efficiency and reducing energy consumption by analyzing past operation data using a machine learning algorithm and learning the vehicle's operation pattern.

In some examples, the camera unit and the microphone unit have a function of generating appropriate feedback based on the passenger's emotional state and sound environment to improve passenger comfort, and providing it to the passenger through the output unit.

An example system for evaluating a driving state of a driver may include circuitry. The circuitry may be configured to: detect a blinking frequency, an eye opening and closing time, a gaze direction, and a head tilt based on a driver's face monitored by a camera; analyze changes in a driver's voice tone and manner of speaking based on vehicle audio collected by a microphone; evaluate a driver's condition by integrating data from the camera and the microphone; and provide a voice warning to the driver when drowsiness or dangerous driving of the driver is detected.

In some examples, evaluating the driver's condition may include learning a driver's driving pattern using a machine learning algorithm and providing advice optimized for an individual driver.

In some examples, providing the voice warning to the driver may include, when dangerous driving is detected, analyzing driving behavior including a sudden lane change or sudden acceleration in real time and providing specific driving instructions to the driver by voice.

An example method of evaluating a driving state of a driver may include: detecting a blinking frequency, an eye opening and closing time, a gaze direction, and a head tilt based on a face of the driver monitored by a camera; analyzing changes in a voice tone and a manner of speaking of the driver based on in-vehicle audio collected by a microphone; evaluating a condition of the driver by integrating data from the camera and the microphone; and providing a warning by voice to the driver when drowsiness or dangerous driving of the driver is detected.

What is claimed is:

1. A system for evaluating a driving state of a driver, the system comprising circuitry,
wherein the circuitry is configured to:
detect a blinking frequency, an eye opening and closing time, a gaze direction, and a head tilt based on a driver's face monitored by a camera;
analyze changes in a driver's voice tone and manner of speaking based on vehicle audio collected by a microphone;
evaluate a driver's condition by integrating data from the camera and the microphone; and
provide a voice warning to the driver when drowsiness or dangerous driving of the driver is detected.

2. The system according to claim 1, wherein evaluating the driver's condition includes learning a driver's driving pattern using a machine learning algorithm and providing advice optimized for an individual driver.

3. The system according to claim 1, wherein providing the voice warning to the driver includes, when dangerous driving is detected, analyzing driving behavior including a sudden lane change or sudden acceleration in real time and providing specific driving instructions to the driver by voice.

4. A method of evaluating a driving state of a driver, the method comprising:
detecting a blinking frequency, an eye opening and closing time, a gaze direction, and a head tilt based on a face of the driver monitored by a camera;
analyzing changes in a voice tone and a manner of speaking of the driver based on in-vehicle audio collected by a microphone;
evaluating a condition of the driver by integrating data from the camera and the microphone; and
providing a warning by voice to the driver when drowsiness or dangerous driving of the driver is detected.
